(19) United States
(12) Patent Application Publication
(10) Pub. No.: US 2021/0382645 A1
(43) Pub. Date: Dec. 9, 2021

(54) FILE PROCESSING METHOD, COMPUTER DEVICE AND READABLE STORAGE MEDIUM

(71) Applicant: HON HAI PRECISION INDUSTRY CO., LTD., New Taipei (TW)

(72) Inventor: PO-CHUNG WANG, New Taipei (TW)

(21) Appl. No.: 17/220,476

(22) Filed: Apr. 1, 2021

(30) Foreign Application Priority Data
Jun. 3, 2020 (CN) 202010495932.3

(51) Int. Cl. G06F 3/06

(52) U.S. Cl. CPC G06F 3/0647; G06F 3/0673; G06F 3/0604

(57) ABSTRACT

A file processing method applied to a computer device is provided. The method includes pre-establishing a first temporary storage folder, a second temporary storage folder, and a plurality of target folders. A monitoring whether there is a new file stored in the first temporary storage folder. A message about the new file is published when the first temporary storage folder stores the new file. The new file is moved from the first temporary storage folder to the second temporary storage folder according to the message about the new file. Once a result of processing of the new file is obtained, the new file is moved from the second temporary storage folder to one of the plurality of target folders which corresponds to the result of processing of the new file.

### FIELD

The present disclosure relates to computing technology, in particular to a file processing method, a computer device, and a readable storage medium.

### BACKGROUND

Generally, when processing big data files, such as ETL (Extract-Transform-Load) files, errors or unmanageable situations may occur. In a process of file recovery, which files were processed successfully and which files processed unsuccessfully and need to be processed again were analyzed based on log records. It is too cumbersome and consumes time and manpower in the process of searching for problematic files based on the log records.

### BRIEF DESCRIPTION OF THE DRAWINGS

FIG. 1 illustrates a schematic diagram of a computer device according to one embodiment of the present disclosure.

FIG. 2 shows one embodiment of modules of a file processing system of the present disclosure.

FIG. 3 shows a flow chart of one embodiment of a file processing method of the present disclosure.

### DETAILED DESCRIPTION

In order to provide a more clear understanding of the objects, features, and advantages of the present disclosure, the same are given with reference to the drawings and specific embodiments. It should be noted that the embodiments in the present disclosure and the features in the embodiments may be combined with each other without conflict.

In the following description, numerous specific details are set forth in order to provide a full understanding of the present disclosure. The present disclosure may be practiced otherwise than as described herein. The following specific embodiments are not to limit the scope of the present disclosure.

Unless defined otherwise, all technical and scientific terms herein have the same meaning as used in the field of the art technology as generally understood. The terms used in the present disclosure are for the purposes of describing particular embodiments and are not intended to limit the present disclosure.

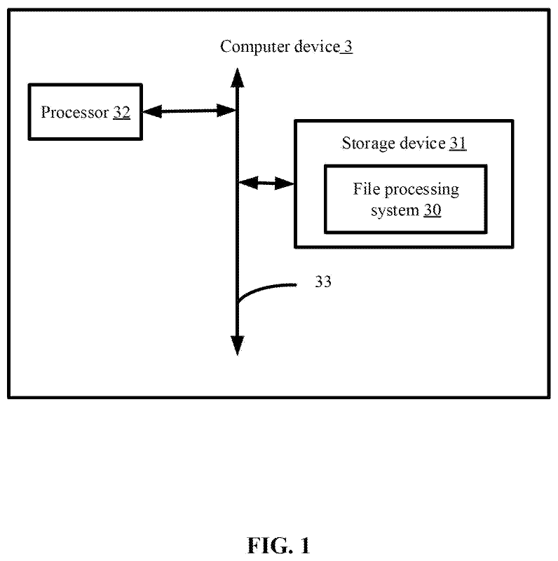

FIG. 1 illustrates a schematic diagram of a computer device of the present disclosure.

In at least one embodiment, the computer device 3 includes a storage device 31, at least one processor 32, at least one communication bus 33. The storage device 31 and the at least one processor 32 are in electrical communication with each other through the at least one communication bus 33.

Those skilled in the art should understand that the structure of the computer device 3 shown in FIG. 1 does not constitute a limitation of the embodiment of the present disclosure. The computer device 3 can further include more or less other hardware or software than that shown in FIG. 1, or the computer device 3 can have different component arrangements.

It should be noted that the computer device 3 is merely an example. If another kind of computer device can be adapted to the present disclosure, it should also be included in the protection scope of the present disclosure, and incorporated herein by reference

In some embodiments, the storage device 31 may be used to store program codes and various data of computer programs. For example, the storage device 31 may be used to store a file processing system 30 installed in the computer device 3 and implement completion of storing programs or data during an operation of the computer device 3. The storage device 31 may include Read-Only Memory (ROM), Programmable Read-Only Memory (PROM), and Erasable Programmable Read-Only Memory. EPROM), One-time Programmable Read-Only Memory (OTPROM), Electronically-Erasable Programmable Read-Only Memory (EEPROM), Compact Disc (Compact Disc) Read-Only Memory (CD-ROM) or other optical disk storage, disk storage, magnetic tape storage, or any other non-transitory computer-readable storage medium that can be used to carry or store data.

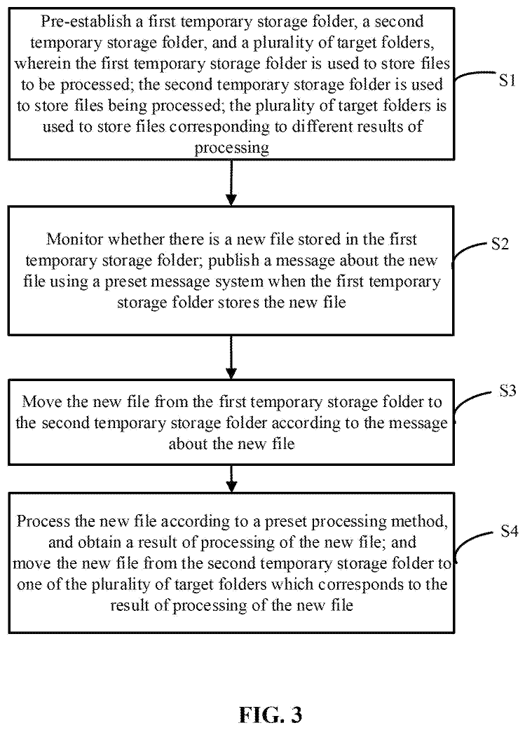

In some embodiments, the at least one processor 32 may be composed of an integrated circuit. For example, the at least one processor 32 can be composed of a single packaged integrated circuit or can be composed of multiple packaged integrated circuits with the same function or different function. The at least one processor 32 includes one or more central processing units (CPUs), one or more microprocessors, one or more digital processing chips, one or more graphics processors, and various control chips. The at least one processor 32 is a control unit of the computer device 3. The at least one processor 32 uses various interfaces and lines to connect various components of the computer device 3, and executes programs or modules or instructions stored in the storage device 31, and invokes data stored in the storage device 31 to perform various functions of the computer device 3 and to process data, for example, perform a function of processing files (for details, see the description of FIG. 3).

In some embodiments, the at least one communication bus 33 is used to implement communication connection between the storage device 31 and the at least one processor 32 and other elements of the computer device 3.

In this embodiment, the file processing system 30 can include one or more modules. The one or more modules are stored in the storage device 31 and are executed by at least one processor (e.g. processor 32 in this embodiment), such that a function of processing files (for details, see the introduction to FIG. 3 below) is achieved.

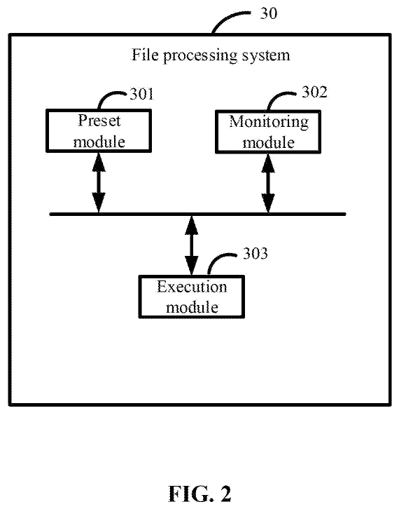

In this embodiment, the file processing system 30 can include a plurality of modules. Referring to FIG. 2, the plurality of modules includes a preset module 301, a monitoring module 302, and an execution module 303. The module referred to in the present disclosure refers to a series of computer-readable instructions that can be executed by at least one processor (for example, the processor 32), and can complete functions, and can be stored in a storage device (for example, the storage device 31 of the computer device 3). In this embodiment, functions of each module will be described in detail with reference to FIG. 3.

In this embodiment, an integrated unit implemented in a form of a software module can be stored in a non-transitory readable storage medium. The above modules include one or more computer-readable instructions. The computer device 3 or a processor implements the one or more computer-readable instructions, such that the method for processing files shown in FIG. 3 is achieved.

In a further embodiment, referring to FIG. 2, the at least one processor 32 can execute an operating system of the computer device 3, various types of applications (such as the file processing system 30 described above), program codes, and the like.

In a further embodiment, the storage device 31 stores program codes of a computer program, and the at least one processor 32 can invoke the program codes stored in the storage device 31 to achieve related functions. For example, each module of the file processing system 30 shown in FIG. 2 is program code stored in the storage device 31. Each module of the file processing system 30 shown in FIG. 2 is executed by the at least one processor 32, such that the functions of the modules are achieved, and the purpose of processing files (see the description of FIG. 3 below for details) is achieved.

In one embodiment of the present disclosure, the storage device 31 stores one or more computer-readable instructions, and the one or more computer-readable instructions are executed by the at least one processor 32 to achieve a purpose of processing files. Specifically, the computer-readable instructions executed by the at least one processor 32 to achieve the purpose of processing files is described in detail in FIG. 3 below.

It should be noted that, in other embodiments, the file processing system 30 may also be implemented as an embedded system with a storage device, a processor, and other necessary hardware or software.

FIG. 3 is a flowchart of a file processing method according to a preferred embodiment of the present disclosure.

In this embodiment, the file processing method can be applied to the computer device 3. For the computer device 3 that requires processing files, the computer device 3 can be directly integrated with the function of processing files. The computer device 3 can also achieve the function of processing files by running a Software Development Kit (SDK).

FIG. 3 shows a flow chart of one embodiment of a file processing method. Referring to FIG. 3, the method is provided by way of example, as there are a variety of ways to carry out the method. The method described below can be carried out using the configurations illustrated in FIG. 1, for example, and various elements of these figures are referenced in explanation of method. Each block shown in FIG. 3 represents one or more processes, methods, or subroutines, carried out in the method. Furthermore, the illustrated order of blocks is illustrative only and the order of the blocks can be changed. Additional blocks can be added or fewer blocks can be utilized without departing from this disclosure. The example method can begin at block S1.

At block S1, the preset module 301 pre-establishes a first temporary storage folder, a second temporary storage folder, and a plurality of target folders. The first temporary storage folder is used to store files to be processed; the second temporary storage folder is used to store files being processed; and the plurality of target folders are used to store files corresponding to different results of processing.

In one embodiment, the plurality of target folders include a first target folder, a second target folder, and a third target folder.

The first target folder is used to store files of which a file format is not supported. That is, the first target folder is used to store files that cannot be opened.

The second target folder is used to store files that are processed successfully. For example, the files that are processed successfully may include files that are processed in accordance with a preset processing mode.

The third target folder is used to store files that are processed unsuccessfully. For example, the files that are processed unsuccessfully may be those in which errors arise during processing.

In one embodiment, the preset module 301 can store files that are to be processed in the first temporary storage folder in response to user input.

At block S2, the monitoring module 302 monitors in real time whether there is a new file stored in the first temporary storage folder. When the first temporary storage folder stores the new file, the monitoring module 302 publishes a message about the new file uses a preset message system.

In this embodiment, the new file may be defined as a file newly stored in the first temporary storage folder, i.e., a file that is not already monitored by the monitoring module 302, but is monitored for the first time by the monitoring module 302 currently.

Specifically, the monitoring module 302 can identify whether the new file is stored in the first temporary storage folder by monitoring parameters such as a file name, a file type, a modification date of a file, and/or a file size of the first temporary storage folder.

In an embodiment, the preset message system is a Kafka distributed publish-subscribe messaging system.

In one embodiment, the message about the new file includes a position of the new file in the first temporary storage folder, a file name of the new file, and the like information.

Specifically, the monitoring module 302 controls the preset message system to add the message about the new file to a message queue of the preset message system.

At block S3, the execution module 303 receives the message about the new file, and moves the new file from the first temporary storage folder to the second temporary storage folder according to the message about the new file.

Specifically, the execution module 303 moves the new file from the first temporary storage folder to the second temporary storage folder according to the position of the new file in the first temporary storage folder.

It should be noted that the term “move” in the context of this embodiment refers to a change of position. If the new file is moved from the first temporary storage folder to the second temporary storage folder, it means that the position of the new file has changed from the first temporary storage folder to the second temporary storage folder.

At block S4, the execution module 303 processes the new file according to a preset processing method, and obtains a result of processing of the new file. The execution module 303 moves the new file from the second temporary storage folder to one of the plurality of target folders which corresponds to the result of processing of the new file.

In an embodiment, the preset processing method includes, but is not limited to, copying data of the new file, deleting duplicate data from the new file, and so on.

In one embodiment, the execution module 303 first determines whether the file format of the new file is a processable file format (the processable file format can also be named as supportable file format).

In this embodiment, the execution module 303 determines whether the file format of the new file is the processable file format is to determine whether the new file can be opened by the execution module 303.

Specifically, the determining whether the file format of the new file is the processable file format includes: determining whether the file format of the new file is one of preset formats (such as .doc format, .xls format, tif format); determining that the file format of the new file is the processable file format if the file format of the new file is one of the preset formats; determining that the file format of the new file is not the processable file format if the file format of the new file is not any one of the preset formats.

When the file format of the new file is not the processable file format, the execution module 303 moves the new file from the second temporary storage folder to the first target folder of the plurality of target folders. As mentioned above, the first target folder can be used to store files of which the file format is not processable. In other words, the result of processing corresponding to the first target folder is “file format is not supported”.

When the file format of the new file is the processable file format, and the new file is processed successfully according to the preset processing method (for example, required data is copied successfully from the new file by the execution module 303), the execution module 303 moves the new file from the second temporary storage folder to the second target folder of the plurality of target folders. As method above, the second target folder can be used to store file which are processed successfully.

When the file format of the new file is the processable file format and the new file is processed unsuccessfully according to the preset processing method (for example, an error occurs during processing the new file, and the new file cannot be processed successfully), the execution module 303 moves the new file from the second temporary storage folder to the third target folder of the plurality of target folders.

It should be noted that, in this embodiment, when the new file is moved from the second temporary storage folder to any one of the plurality of target folders, the second temporary storage no longer stores the new file.

In one embodiment, after the execution module 303 moves the new file from the second temporary storage folder to any one of the plurality of target folders, the execution module 303 also notifies the preset messaging system that the new file has been processed by sending a notification to the preset messaging system.

In one embodiment, when the preset message system receives the notification, the preset message system deletes the message about the new file from the message queue of the preset message system.

In one embodiment, the execution module 303 further processes following operations under a condition that the new file is closed unintentionally and needs to be reopened during a process of processing the new file according to the preset processing method: re-acquiring the message about the new file from the preset message system, and obtaining the new file from the first temporary storage folder, according to the position of the new file in the first temporary storage folder (the position of the new file in the first temporary storage folder is included in the message about the new file); obtaining the new file from the second temporary storage folder file when the new file is not obtained from the first temporary storage folder.

In one embodiment, when the execution module 303 does not obtain the new file from the second temporary storage folder, the execution module 303 determines that the new file has been processed. When it is determined that the new file has been processed, the execution module 303 sends the notification to the preset message system. Therefore, when the preset message system receives the notification, the preset message system deletes the message about the new file from the message queue of the preset message system.

The above description is only embodiments of the present disclosure, and is not intended to limit the present disclosure, and various modifications and changes can be made to the present disclosure. Any modifications, equivalent substitutions, improvements, etc. made within the spirit and scope of the present disclosure are intended to be included within the scope of the present disclosure.

What is claimed is:

1. A file processing method applied to a computer device, the method comprising:
pre-establishing a first temporary storage folder, a second temporary storage folder, and a plurality of target folders, wherein the first temporary storage folder is used to store files to be processed; the second temporary storage folder is used to store files being processed; the plurality of target folders is used to store files corresponding to different results of processing;
monitoring whether there is a new file stored in the first temporary storage folder;
publishing a message about the new file using a preset message system when the first temporary storage folder stores the new file;
moving the new file from the first temporary storage folder to the second temporary storage folder according to the message about the new file;
processing the new file according to a preset processing method, and obtaining a result of processing of the new file; and
moving the new file from the second temporary storage folder to one of the plurality of target folders which corresponds to the result of processing of the new file.

2. The file processing method according to claim 1, further comprising:
determining whether a file format of the new file is a processable file format;
moving the new file from the second temporary storage folder to a first target folder of the plurality of target folders, when the file format of the new file is not the processable file format;
moving the new file from the second temporary storage folder to a second target folder of the plurality of target folders, when the file format of the new file is the processable file format, and the new file is processed successfully according to the preset processing method; and
moving the new file from the second temporary storage folder to a third target folder of the plurality of target folders, when the file format of the new file is the processable file format and the new file is processed unsuccessfully according to the preset processing method.

3. The file processing method according to claim 2, further comprising:
notifying the preset messaging system that the new file has been processed by sending a notification to the preset messaging system, when the new file is moved from the second temporary storage folder to any one of the plurality of target folders.

4. The file processing method according to claim 3, wherein the preset message system deletes the message about the new file from a message queue of the preset message system, when the preset message system receives the notification.

5. The file processing method according to claim 4, wherein the message about the new file comprises a position of the new file in the first temporary storage folder, and a file name of the new file.

6. The file processing method according to claim 5, further comprising the following operations under a condition that the new file is closed unintentionally and needs to be reopened during a process of processing the new file according to the preset processing method:
re-acquiring the message about the new file from the preset message system, and obtaining the new file from the first temporary storage folder, according to the position of the new file in the first temporary storage folder; and
obtaining the new file from the second temporary storage folder file when the new file is not obtained from the first temporary storage folder.

7. The file processing method according to claim 6, further comprising:
determines that the new file has been processed when the new file is not obtained from the second temporary storage folder; and
sending the notification to the preset message system.

8. A computer device comprising:
a storage device;
at least one processor; and
the storage device storing one or more programs, which when executed by the at least one processor, cause the at least one processor to:
pre-establish a first temporary storage folder, a second temporary storage folder, and a plurality of target folders, wherein the first temporary storage folder is used to store files to be processed; the second temporary storage folder is used to store files being processed; the plurality of target folders is used to store files corresponding to different results of processing;
monitor whether there is a new file stored in the first temporary storage folder;
publish a message about the new file using a preset message system when the first temporary storage folder stores the new file;
move the new file from the first temporary storage folder to the second temporary storage folder according to the message about the new file;
process the new file according to a preset processing method, and obtain a result of processing of the new file; and
move the new file from the second temporary storage folder to one of the plurality of target folders which corresponds to the result of processing of the new file.

9. The computer device according to claim 8, wherein the at least one processor is further caused to:
determine whether a file format of the new file is a processable file format;
move the new file from the second temporary storage folder to a first target folder of the plurality of target folders, when the file format of the new file is not the processable file format;
move the new file from the second temporary storage folder to a second target folder of the plurality of target folders, when the file format of the new file is the processable file format, and the new file is processed successfully according to the preset processing method; and
move the new file from the second temporary storage folder to a third target folder of the plurality of target folders, when the file format of the new file is the processable file format and the new file is processed unsuccessfully according to the preset processing method.

10. The computer device according to claim 9, wherein the at least one processor is further caused to:
notify the preset messaging system that the new file has been processed by sending a notification to the preset messaging system, when the new file is moved from the second temporary storage folder to any one of the plurality of target folders.

11. The computer device according to claim 10, wherein the preset message system deletes the message about the new file from a message queue of the preset message system, when the preset message system receives the notification.

12. The computer device according to claim 11, wherein the message about the new file comprises a position of the new file in the first temporary storage folder, and a file name of the new file.

13. The computer device according to claim 12, wherein the at least one processor is further caused to execute the following operations under a condition that the new file is closed unintentionally and needs to be reopened during a process of processing the new file according to the preset processing method:
re-acquiring the message about the new file from the preset message system, and obtaining the new file from the first temporary storage folder, according to the position of the new file in the first temporary storage folder; and
obtaining the new file from the second temporary storage folder file when the new file is not obtained from the first temporary storage folder.

14. The computer device according to claim 13, wherein the at least one processor is further caused to:
determine that the new file has been processed when the new file is not obtained from the second temporary storage folder; and
send the notification to the preset message system.

15. A non-transitory storage medium having instructions stored thereon, when the instructions are executed by a processor of a computer device, the processor is configured to perform a file processing method, wherein the method comprises:
pre-establishing a first temporary storage folder, a second temporary storage folder, and a plurality of target folders, wherein the first temporary storage folder is used to store files to be processed; the second temporary storage folder is used to store files being processed; the plurality of target folders is used to store files corresponding to different results of processing;
monitoring whether there is a new file stored in the first temporary storage folder;
publishing a message about the new file using a preset message system when the first temporary storage folder stores the new file;
moving the new file from the first temporary storage folder to the second temporary storage folder according to the message about the new file;
processing the new file according to a preset processing method, and obtaining a result of processing of the new file; and
moving the new file from the second temporary storage folder to one of the plurality of target folders which corresponds to the result of processing of the new file.

16. The non-transitory storage medium according to claim 15, wherein the method further comprises:
determining whether a file format of the new file is a processable file format;
moving the new file from the second temporary storage folder to a first target folder of the plurality of target folders, when the file format of the new file is not the processable file format;
moving the new file from the second temporary storage folder to a second target folder of the plurality of target folders, when the file format of the new file is the processable file format, and the new file is processed successfully according to the preset processing method; and
moving the new file from the second temporary storage folder to a third target folder of the plurality of target folders, when the file format of the new file is the processable file format and the new file is processed unsuccessfully according to the preset processing method.

17. The non-transitory storage medium according to claim 16, wherein the method further comprises:
notifying the preset messaging system that the new file has been processed by sending a notification to the preset messaging system, when the new file is moved from the second temporary storage folder to any one of the plurality of target folders.

18. The non-transitory storage medium according to claim 17, wherein the preset message system deletes the message about the new file from a message queue of the preset message system, when the preset message system receives the notification.

19. The non-transitory storage medium according to claim 18, wherein the message about the new file comprises a position of the new file in the first temporary storage folder, and a file name of the new file.

20. The non-transitory storage medium according to claim 19, wherein the method further comprising the following operations under a condition that the new file is closed unintentionally and needs to be reopened during a process of processing the new file according to the preset processing method:
re-acquiring the message about the new file from the preset message system, and obtaining the new file from the first temporary storage folder, according to the position of the new file in the first temporary storage folder; and
obtaining the new file from the second temporary storage folder file when the new file is not obtained from the first temporary storage folder.
